(19) United States
(12) Patent Application Publication
(10) Pub. No.: US 2004/0252187 A1
(43) Pub. Date: Dec. 16, 2004

(54) Processes and apparatuses for efficient multiple program and 3D display

(76) Inventor: Ray M. Alden, Raleigh, NC (US)

Correspondence Address: Ray M. Alden, 808 Lake Brandon Trail, Raleigh, NC, 27610, US

(21) Appl. No.: 10/884,423

(22) Filed: Jul. 3, 2004

Related U.S. Application Data
(63) Continuation-in-part of application No. 10/455,578, filed on Jun. 5, 2003.
(63) Continuation-in-part of application No. 09/950,300, filed on Sep. 10, 2001.
(60) Provisional application No. 60/473,865, filed on May 29, 2003.

(51) Int. Cl. H04N 9/12

(52) U.S. Cl. 348/51; 348/771; 348/744; 348/739

(57) ABSTRACT

This invention provides a front projection display means which uses time sequenced addressing to physically segment viewer space into segments which each receive different respective full resolution image streams (or television programs). The display uses a pixel generation mechanism such as a three chip DLP projector to generate a rapid succession of pixels which are rapidly swept across the viewer space using an array of rotating micro mirrors that are rotated in sync with the generation of images by the DLP projector to horizontally address an optimized user space with positionally dependent images. Each mirror on the is approximately the size of a pixel that is incident upon the projection screen and also has a specific vertical curvature to ensure that light that it reflects at any given instance in time can be seen throughout a mathematically determined exhaustive vertical viewer plane while only being seen in a very narrow horizontal plane. This rotating micro mirror array screen and the optimized user space described herein provide a very reliable, high resolution, bright imaging display system for displaying images with very high resolution auto stereoscopic 3D or multiple concurrent programs.

### CROSS REFERENCE TO RELATED APPLICATIONS

This application is a Continuation in part of patent application Ser. No. 10/455,578 which was filed on Jun. 5, 2003 by the same title and which was a conversion of Provisional Application 60/473,865 filed with the USPTO on May 28, 2003 and which was a Continuation in part of patent application Ser. No. 09/950,300 which was filed on Sep. 10, 2001 titled “Multiple Bit Stream Directional Video Monitor Apparatus and Process”. This application is also a Continuation in Part of the Provisional Application filed Jun. 18, 2003 titled “Time Sequenced User Space Segmentation For Multiple Program and 3D Display”. This application is also a Continuation in Part of the Provisional Application filed Jun. 27, 2003 titled “Time Sequenced User Space Segmentation For Multiple Program and 3D Display”. This application is also a Continuation in Part of the Provisional Application filed Jul. 7, 2003 titled “Time Sequenced User Space Segmentation For Multiple Program and 3D Display”. This application is also a Continuation in Part of the Provisional Application filed Jul. 9, 2003 titled “Time Sequenced User Space Segmentation For Multiple Program and 3D Display”. This application is also a Continuation in Part of the Provisional Application filed Jul. 16, 2003 titled “Time Sequenced User Space Segmentation For Multiple Program and 3D Display”. This application is also a Continuation in Part of the Provisional Application filed Oct. 29, 2003 titled “Sub-Image Steering Means and Method for Multiple Program Display and 3D Display”. This application also comprises filing in the US of art disclosed in PCT/US 04/16563 filed May 27, 2004. These applications are incorporated herein by reference.

### BACKGROUND FIELD OF INVENTION

Modern video monitors incorporate many technologies and methods for providing high quality video to users. Nearly every household in the United States has one or more video monitors in the form of a television or a computer monitor. These devices generally use technologies such as Cathode Ray Tubes (CRT) tubes, FEDs, Liquid Crystal Displays (LCD), OLEDs, Plasma, Lasers, LCoS, or Digital Micromirror Devices (DMD) projection in one way or another. Large monitors offer the advantage of enabling many users to see the video monitor simultaneously as in a living room television application for example. Often video users do not want to view the same image streams as one another. Instead viewers would often like to see completely different programs or image streams at the same time. Alternately viewers would like to see the same program in 3D (three-dimensional) format.

The prior art describes some attempts to enable multiple viewers to see different image streams concurrently on the same monitor. These are generally drawn to wearing glasses that use polarization or light shutters to filter out the unwanted video stream while enabling the desired video stream to pass to the users' eyes. No known prior art provides a technique to enable multiple viewers to view separate video streams concurrently with the unaided eye. The prior art also describes displays which use time sequenced spatial multiplexing as a means to enable multiple viewers to view auto stereoscopic 3D images on the same screen concurrently. Moreover, no practicable large screen display adequately incorporates multiple program viewing with auto-stereoscopic 3D to be viewed from the same Television pixels at the virtually the same time by multiple viewers.

The present invention provides a significant step forward for video monitors. The present invention describes display architectures that can be used with many display technologies together with a specific implementation in a large rotating mirror array which enables multiple high resolution video streams and/or perspectives of the same 3D video stream to be displayed on the same projection display screen concurrently using time sequenced spatial multiplexing. Concurrent presentation and separation of video streams is achieved using the same number of pixels for each respective stream. A high speed pixel generator such as a three chip DLP engine is synchronized with a large array of rotating mirrors comprising a vertically dispersive and horizontally non dispersive time sequenced viewing medium. This technique enables directing of a first program or 3-D perspective to a first user while directing a second program of 3-D perspective to a second user. Pixel steering mirrors cause the pixel to be time sequenced and swept across or moved to a range of positions across the user space thus dividing the user space into time sequenced positional segments where each segment receives different light from the same pixel. Thus the view one sees from the display is dependent upon the physical position he or she is in relative to the display. The result is that multiple users can sit in respective viewing segments wherein people in each of the segments can view different video streams on the same display concurrently. Alternately, viewers will see an auto-stereoscopic 3D image which is dependant upon their position relative to the display.

### BACKGROUND-DESCRIPTION OF PRIOR INVENTION

The prior art describes some attempts to enable multiple viewers to see different video streams concurrently on the same monitor. These are generally drawn to wearing glasses that use polarization or light shutters to filter out the unwanted video stream while enabling the desired video stream to pass to the users' eyes. U.S. Pat. No. 6,188,442 Narayanaswami being one such patent wherein the users wear special glasses to see their respective video streams. U.S. Pat. No. 2,832,821 DuMont does provide a device that enables two viewers to see multiple polarized images from the same polarizing optic concurrently. DuMont however also requires that the viewers use separate polarizing screens as portable viewing aids similar to the glasses. DuMont further requires the expense of using two monitors concurrently. No known prior art provides a technique to enable multiple viewers to view separate video streams on the same projection screen concurrently with the unaided eye as does the present invention.

The so called “Cambridge Display” or “Travis Display” provides a well publicized means for using time sequential spatially multiplexed viewing zones as a method to enable multiple viewers to see auto-stereoscopic 3-D images on a display. This technique is described in U.S. Pat. No. 5,132,839 Travis 1992, U.S. Pat. No. 6,115,059 Son et al 2000, and U.S. Pat. No. 6,533,420 Eichenlaub 2003. The technique is also described in other documents including; “A time sequenced multi-projector auto-stereoscopic display”, Dodgson et al, Journal of the Society for Information Display 8(2), 2000, pp 169-176; “A 50 inch time-multiplexed auto-stereoscopic display” Proceedings SPIE Vol 3957, 24-26 Jan. 2000, San Jose Calif., Dodgson, N. A., et al.; Proceedings SPIE Vol 2653, Jan. 28-Feb. 2, 1996, San Jose, Calif., Moore, J. R., et al.; and can be viewed at http://www.cl.carmac.uk/Research/Rainbow/projects/asd.html. This prior art typically relies on optics to first compress the entire image from a pixel generator such as a CRT tube, secondly an optical element such as a shutter operates as a moving aperture that selects which orientation of the entire compressed image can pass therethrough, thirdly, additional optics magnify the entire image, and fourthly the image is presented to a portion of viewer space. This process is repeated at a rate of approximately 60 hertz with the shutter mechanism operating in sync with the pixel generator to present different 3D views to different respective portions of viewer space. Two main disadvantages of this prior art are easily observable when viewing their prototypes. A first disadvantage is that a large distance on the order of feet is required between the first set of optics and the steering means, and between the steering means and the second set of optics. This disadvantage results in a display that is far too bulky for consumer markets or for any flat panel display embodiments. Secondly, looking at the display through large distances between optics creates a tunnel effect that tends to diminish the apparent viewable surface area of the resultant viewing screen.

According to Deep Light of Hollywood, Calif., the intellectual property comprising the “Cambridge display” is owned and being advanced by Deep Light. Also Physical Optics Corporation describes on their website that they are currently building a prototype of a time sequenced 3D display using liquid crystal beam steering at the pixel level similarly to that which has been described by the present applicant in the related applications referenced in this document.

By contrast the present invention is not cumbersome, having a front projection means with a screen on a wall and the projection apparatus on the ceiling. The present invention is therefore compatible with a vast number of consumer applications. The present invention uses a projection screen comprised of many rotating mirrors, each no larger than the size of an incident projected pixel, to steer images into user space. Moreover, in addition to its 3-D auto-stereoscopic use, the present invention uses time sequential spatially multiplexed viewing zones to provide a new use of enabling multiple viewers to watch completely different image streams or programs on the same projection screen at the same time. Also the present invention includes a processing step that relies on the position of the multiple users and the shape of users space to reduce the processing of perspectives and portions of perspectives that will not be observed by users.

### BRIEF SUMMARY

The invention described herein represents a significant improvement for the users of large screen front projection based displays. Heretofore a large family size television for example could only carry one video stream on its entire surface at any given time. Anyone not interested in watching the same video stream was required to use a television in another room or in the case of “picture in picture” to view the video stream on a smaller portion of the same monitor. Likewise if a family member wanted to use the computer or video game, they would have to go to a separate computer or gaming station with a monitor. The present invention enables multiple users to use one large projection display concurrently while each views and hears completely different video content concurrently whether television video, computer video, gaming video, or some other form of video. Also, the present display includes a memory describing the sweet spots for historic user position and room shape and then processes and presents only portions of images that are viewable within this sweet spot. This eliminates the processing of portions of images that will not be viewed by users thus freeing up processing power to maximize the horizontal parallax resolution (in the 3D application) and number of concurrent video streams presented.

The present invention also provides auto-stereoscopic 3D functionality in the same projection display as above.

The present invention uses a process of time sequenced iterative sweeping of pixels across the user space to physically segment the user space into physically segmented viewing spaces. As light from individual pixels is swept across the user space, each segmented viewing space receives a different color from individual pixels. This process is done concurrently for many thousands of pixels such that a multitude of positionally dependent normal resolution images are produced from the same video display device. Thus each respective space segment receives a different respective full resolution image from the display. Viewers in different segments can watch different programs at the same time. Alternately, each viewing space segment receives a perspective correct view of a true 3D image.

Users within respective user spaces each see unique video streams across the entire surface of the video display screen which are not visible to those in other respective user spaces. Using the techniques described, a multitude of video streams can be displayed concurrently on one video display screen. The specific implementation described herein comprises an array of rotating mirrors which are individually smaller than the size of an incident projected pixel and comprise a vertically dispersive and horizontally non-dispersive actuating mirror steering method.

Thus the present invention offers a significant advancement in the functionality of video monitors or displays without diminishing resolution.

### OBJECTS AND ADVANTAGES

Accordingly, several objects and advantages of the present invention are apparent. It is an object of the present invention to provide an image display means which enables multiple viewers to experience completely different video streams simultaneously. This enables families to spend more time together while simultaneously independently experiencing different visual media or while working on different projects in the presence of one another or alternately to concurrently experience true 3D enhanced media. Also, electrical energy can be saved by concentrating visible light energy from a display into narrower user space where a user is positioned. Likewise when multiple users use the same display instead of going into a different room, less electric lighting is required. Also, by enabling one display to operate as multiple displays, living space can be conserved which would otherwise be cluttered with a multitude of displays.

It is an advantage that the present invention doesn't require special eyewear, eyeglasses, goggles, or portable viewing devices as does the prior art.

It is an advantage of the present invention that the same monitor that presents multiple positionally segmented image streams also can provide true positionally segmented 3D images and stereoscopic images.

It is an advantage of the present invention that resolution is not sacrificed in order to achieve 3D images and neither is resolution sacrificed to present multiple concurrent positionally segmented image streams and neither is resolution sacrificed to present stereoscopic image streams.

One of the advantages of using rotating mirrors in array as described herein is that they will reflect light throughout a wide range of deflection angles including reasonable efficiency through a range exceeding forty five decrees off axis. The optimized shape of viewer space can be adjusted on the fly if for example the display is moved to a differently shaped room or the history of viewer positions (as later discussed) changes over time. Also the horizontal parallax resolution of rotating mirrors in array is purely a function of processing speed of the pixel projector and the system driving it and can be changed on the fly or upgraded at any time without replacing the mirror array. Also the rotating mirror array described herein can be used to support very fine horizontal parallax resolution when used in conjunction with user tracking as later described. This makes the mirror array described herein very practical for a wide range of situations and able to exceed the operational speed of available projection devices.

Further objects and advantages will become apparent from the enclosed figures and specifications.

### DRAWING FIGURES

FIG. 1a illustrates a top view of a conventionally shaped effective viewing zone produced by time sequenced spatially multiplexed display of the present invention.

FIG. 1b illustrates a top view of an improved shaped effective viewing zone produced by time sequenced spatially multiplexed display of the present invention.

FIG. 1c illustrates a top view of a specific shaped effective viewing zone produced by time sequenced spatially multiplexed display of the present invention.

FIG. 1d illustrates a top view of a user's eyes observing the images produced in FIG. 1C.

FIG. 2 is a [perspective view of the projection display and corresponding effective viewer space as described in FIG. 1c.

FIG. 3a is a top view of the projection screen of FIG. 2 showing three exemplary pixels projected over a period of 0.00009 seconds.

FIG. 3b is a top view of the exemplary pixels of FIG. 3a projection over a subsequent 0.00009 second period.

FIG. 3c is a top view of the exemplary pixels of FIG. 3b projection over a subsequent 0.00009 second period.

FIG. 4a is a top view of an exemplary mirror during the period described in FIG. 3a.

FIG. 4b is a top view of the exemplary mirror of FIG. 4a during the period described in FIG. 3b.

FIG. 4c is a top view of the exemplary mirror of FIG. 4a during the period described in FIG. 3c.

FIG. 4d is a side view of the method of deriving the necessary vertical curvature of mirror of FIG. 4a to ensure it fully addresses the entire vertical cross section of user space described in FIG. 2.

FIG. 4e is a side view of the surface of the mirror with the curvature derived in FIG. 4d.

FIG. 4d is a side view of the method of deriving the necessary vertical curvature of the top row of mirrors described in FIG. 2 to ensure they fully addresses the entire vertical cross section of user space described in FIG. 2.

FIG. 5 is a perspective view of the method of assembling the components of a single rotating mirror shaped for full instant vertical distribution throughout user space (diffuse) but narrow instant horizontal distribution in user space (non-diffuse).

FIG. 6 depicts a small fully assembled section of uncut mirrors that will form the projection screen of the present invention but prior to the last step of the fabrication process.

FIG. 7 depicts the small section of mirrors of FIG. 6 that comprise a portion of the rotating mirror projection screen of the present invention fully fabricated, cut and ready for operation.

FIG. 8 is a top view of a small section of a row of mirrors similar to those of FIG. 7 together with a schematic for controlling their actuation currently in the off state.

FIG. 9 describes the components of FIG. 8 in the on state at a first moment in time.

FIG. 10 describes the components of FIG. 9 at a second moment in time.

FIG. 11 depicts a flow chart describing the efficient operation of the present invention in the multiple program mode.

FIG. 12a illustrates a top view of multiple users selecting programming choices on the present display.

FIG. 12b depicts the display of FIG. 12a presenting a first program to a first user.

FIG. 12c depicts the display of FIG. 12b at a subsequent time presenting a second program to a second user.

FIG. 12d depicts the display of FIG. 12c at a subsequent time presenting a first program to a first user and concurrently a second program to a second user.

FIG. 13a is identical to FIG. 12b except that a directional sound carrier is concurrently reflected from the projection screen to the first user.

FIG. 13b is identical to FIG. 12c except that a directional sound carrier is concurrently reflected from the projection screen to the second user.

FIG. 13b is identical to FIG. 12d except that a directional sound carrier is concurrently reflected from the projection screen to both the first and second users.

FIG. 14 depicts a flow chart describing the efficient operation of the present invention in the auto-stereoscopic 3D mode.

### DETAILED DESCRIPTION OF THE INVENTION

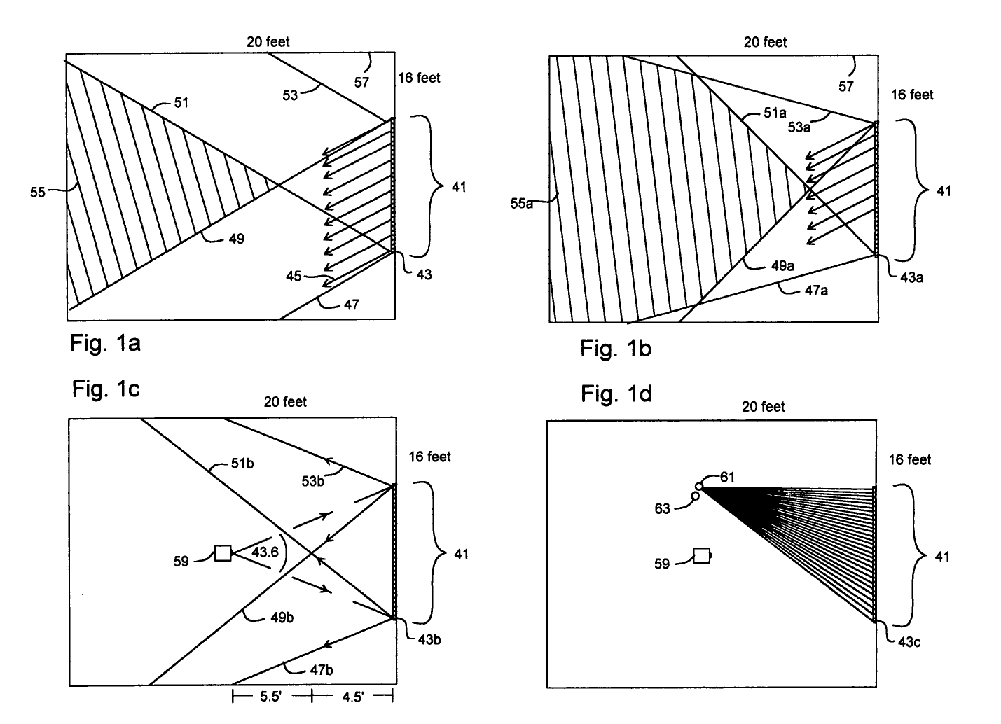

FIG. 1a illustrates a top view of a conventionally shaped effective viewing zone produced by a time sequenced spatially multiplexed display of the present invention. A rotating micro mirror array projection screen 41 is constructed and operated as described later. The rotating mirror array projection screen is comprised of 1408 columns by 1166 rows of rotating mirrors each 0.068 inch wide by 0.041 inch tall with characteristics and fabricated as later described. A first vertically dispersive and horizontally non-dispersive mirror 43 being one such mirror that produces first reflected partial pixel 45. The mirrors such as 43 cooperate to each produce parallel partial pixels which in composite comprise an image. Using time multiplexing, the image produced by the rotating mirror array projection screen varies in sync with the positions of the constituent rotating mirrors including the first vertically dispersive and horizontally non-dispersive mirror 43. As is typical of time sequenced spatially multiplexed displays, over its operating cycle, each pixel can be seen from a range of viewer positions. The partial pixel reflected by 43 can be seen by users throughout the range bounded by a first right most view of pixel 47 and a first left most view of pixel 51. Similarly, the partial pixels reflected from the left most portion of the 41 can be seen by users positioned in the range between a left side of display's left most view of partial pixel 53 and a left side of display's right most view of partial pixel 49. Note that 47 and 51 diverge at a sixty degree angle which is bisected by a normal to 43. The 53 and 49 are similarly situated. Also note that each mirror has a two degree horizontal parallax resolution and thirty separate images are generated to achieve a sixty degree field of view. The intersection of the 51 and the 49 describes a position where, over the course of its operating cycle, every pixel on the display can be seen in a full display view zone 55. Users in the 55 area see pixel light from all of the mirrors on the 41 whereas users not in 55 will see pixel light from only some mirrors and no pixel light from other mirrors. One can easily see that when addressing the twenty foot by sixteen foot room 57, most of the space in the room is not receiving a full image and is not optimal for viewing the display. Moreover, since users will need to be positioned in the 55 to view the image properly, all of the pixels produced and directed outside of 55 represent wasted processing power and wasted electromagnetic radiation energy. The present invention describes techniques to optimize the shape of the optimal viewing zone as described in FIG. 1b

FIG. 1b illustrates a top view of an improved shaped effective viewing zone produced by time sequenced spatially multiplexed display of the present invention. As was the case in FIG. 1a, the divergence angles of light from each mirror is still sixty degrees, the horizontal parallax resolution is still two degrees, and the number of pixels calculated is equivalent to thirty images. However, in FIG. 1b, the divergence angle of a left most pixel 43a is not bisected by a norm to the display but is instead rotated toward the center of the room. In fact assuming that the maximum processing that an image generation system (not shown) can perform will allow only a finite range of viewing angles, the optimized shape viewing zone 55a can be calculated as the point at which the left most light directed from the first operationally optimized mirror 43a such as optimized left most light 51a intersects with right most optimized light from right most mirror 53a and whereby, this intersection of 51a and 53a occurs along the outermost edge of the viewing space 57. Thus the 55a is much larger than the 55. Some methods of optimizing the 55a include moving the projector relative to the 41 to control the divergence angle of the image, shaping the 41 by physically curving it to optimize the dispersive angle of the image, and/or using Fresnel structured mirrors that perform similarly to curving the 41 while actually keeping the 41 flat. Each of these techniques involve significant trade offs that are not discussed herein. A third preferred technique that is part of the present invention for optimizing the size and shape of the optimal viewing zone involves processing and presenting only those pixels that are directed to the optimized viewing zone and not processing and displaying pixels that would not be seen in the optimal viewing zone. This is exemplified in FIG. 1b where the 41 is reflecting light but only to the portions of the room in the optimized viewing space such that the 43a is not reflecting any pixel light at all as part of the image with the depicted trajectory angle. Moreover, to conserve processing power, these portions of the image were not processed by the system nor projected by the DLP. By contrast, the 41 of FIG. 1a reflects the image on trajectory as depicted and the 43 was reflecting a partial pixel to a portion of the room where a viewer would certainly not be present. Thus the processing required to present the pixel to be reflected by 43 in FIG. 1a is conserved in FIG. 1b. In practice, the number of images produced using the technique of FIG. 1b is greater than the number of images produced using the technique of 1a but the average number of pixels per image is far less per image in 1b. Thus the user space is optimized while the processing and image generation functions are more efficiently spread over more images at longer portions of the micro mirror rotating cycle. Also this technique may be able to save enough processing power to enable finer horizontal parallax resolution than was possible in 1a. Moreover in FIG. 1b, image generation capacity of the projector is used during times that it was not used in FIG. 1a. One of the advantages of using rotating mirrors in array as described herein is that they will reflect light throughout a wide range of deflection angles including reasonable efficiency through a range exceeding forty five decrees off axis. The optimized shape of viewer space can be adjusted on the fly if for example the display is moved to a differently shaped room or the history of viewer positions (as later discussed) changes over time. Also the horizontal parallax resolution of rotating mirrors in array is purely a function of processing speed of the pixel projector and the system driving it and can be changed on the fly or upgraded at any time without replacing the mirror array. Also the rotating mirror array described herein can be used to support very fine horizontal parallax resolution when used in conjunction with user tracking as later described. This makes the mirror array described herein very practical for a wide range of situations and able to exceed the operational speed of available projection devices.

FIG. 1c illustrates a top view of a specific shaped effective viewing zone produced by time sequenced spatially multiplexed display of the present invention. A projector 59 comprises three DLP chips with high speed driving circuitry and bus as later described. Such devices can be purchased with displays produced by Actuality Systems, LightSpace Technologies, and DeepLight. A three chip DLP can also be purchased from Delta Electronics and matched with a custom card to achieve suitable driving speeds for the present invention. Optically, the DLP projector uses one DLP for each respective color red, green, and blue and a set of two dichroic mirrors to bring the three colors together and ultimately a collimated image is diverged by projecting optics onto the 41. The diverging optics produce a total divergence angle of 43.6 degrees such that a nearly optimized viewing space is produced beginning 4.5 feet from the 41 and covering much of the user space. The example of FIG. 1c is used in FIG. 1d and ensuing Figures.

FIG. 1d illustrates a top view of a user's eyes observing the images produced in FIG. 1c. A user's left eye 61 receives time sequenced pixel light from thirty images spread across thirty respective segments of 41 including some light from every rotating mirror that was presented to user space in rapid succession by the 41. In the 3D application, a user's right eye 63 will receive a different set of pixels from the same thirty images spread across every mirror on the 41 than did the 61. As the User's right and left eye see different perspectives, the user experiences 3D auto stereoscopic images on the 41. Presenting thirty full or partial images to user space is one way of ensuring a relatively high horizontal parallax and auto stereoscopic resolution. Here we are presenting thirty different perspectives rotated two degrees from one another and spread across a sixty degree field of view. Each time the 61 moves a full degree, every pixel on the display will present to 61a perspective of the image that is also rotated two degrees. If the 61 moves less than two degrees, some pixels will be presented with a two degree perspective rotation while others pixels will not be presented with any perspective rotation. Any users in optimized viewing zone such as 55a will similarly see auto stereoscopic images that include two degree horizontal parallax resolution. A finer horizontal resolution across the whole optimized viewing space 55a is possible if more images are produced which in turn requires more processing and a higher frame rate at the three chip DLP. It is note worthy that this scenario requires no change what so ever in the rotating mirror array of the present invention that will rotate at the same speed no matter how many images are processed by the system and produced by the three chip DLP (as long as the full cycle time of these components remains synchronized with a sixty hertz mirror rotation cycle for example.) It is note worthy that if the processor knows the position of 61 and 63 and there are no other users present, it would actually be able to provide horizontal parallax resolution down to the width of a single rotating mirror. In this case, instead of having thirty lines coming from the 41 representative of 30 slightly different rotated views of a 3D image, 1280 lines would be coming off of the 41 and directed to the 61 representative of a slightly rotated view from every pixel produced by the DLP. Similarly, based on the position of the 63 an additional 1280 slightly rotated views can be calculated by the system, and produced by the DLP and directed to the 63. In this scenario, the DLP would be projecting only two pixel wide columns of light at any given instant in time and would be projecting a total amount of pixels equivalent to only two frames at a rate of sixty hertz. The two frames each consisting of a total of 1280 separately calculated and projected images each only one pixel wide and presented in rapid succession by the DLP to the 41 whereby an individual pixel column is lit up at 120 hertz and 76,800 images each only two pixels wide are produced every second. This enables a much finer horizontal parallax resolution while spreading the processing burden and the DLP image production burden over a suitable period of time.

Thus the rotating mirror array of the present invention can both fill a user space with perspective correct 3D images of reasonable horizontal parallax resolution and alternately can direct very high resolution (certainly less than 0.05 degrees and much finer) to known user positions.

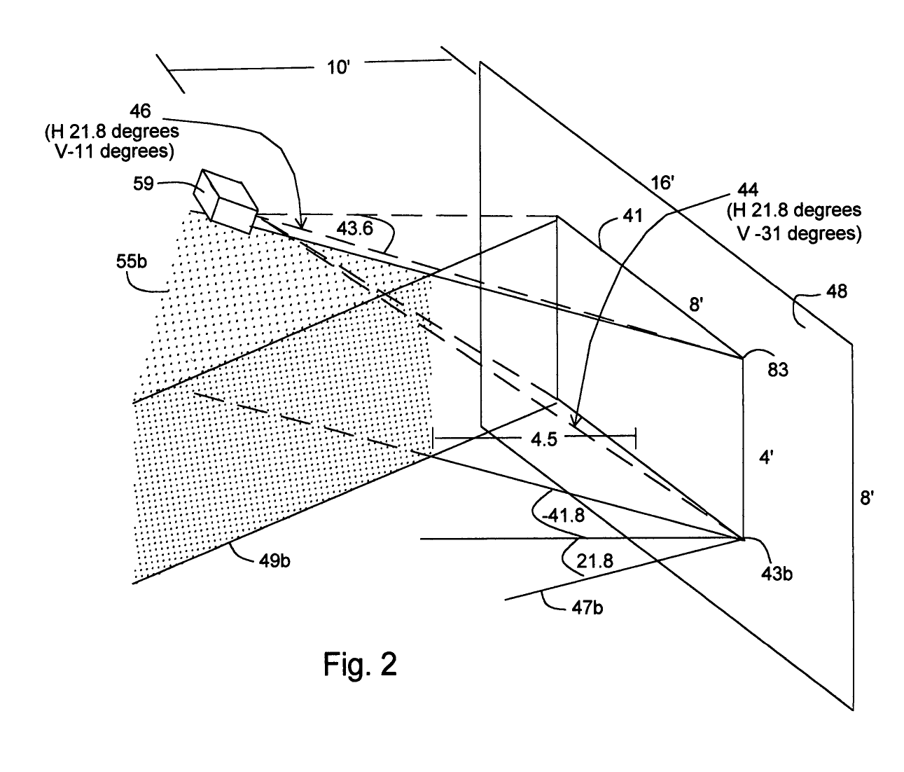

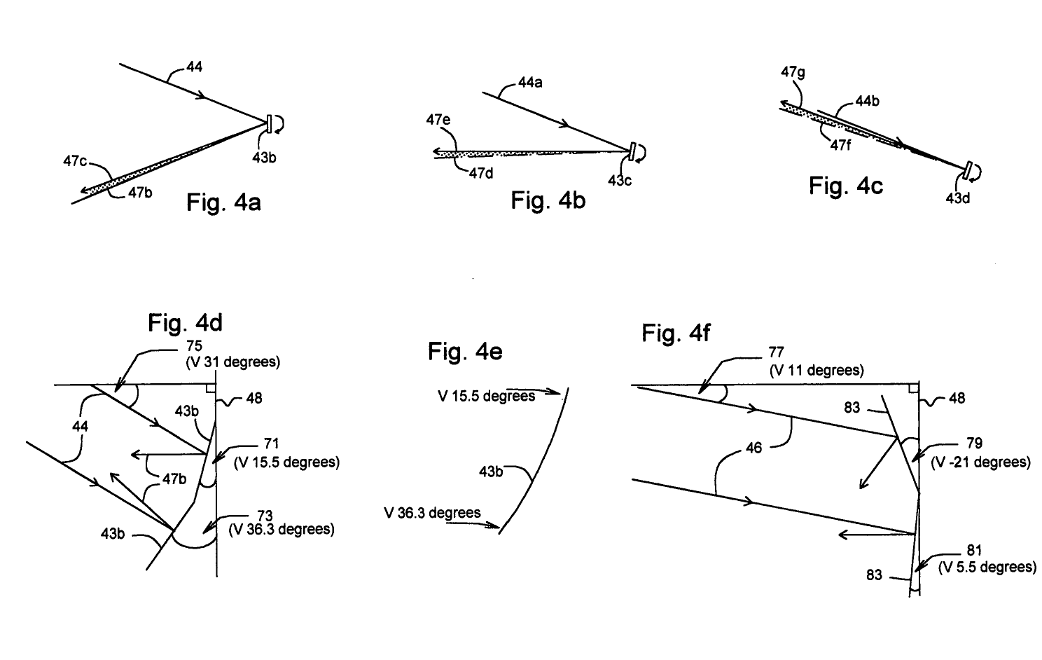

FIG. 2 is a perspective view of the projection display and corresponding effective viewer space as described in FIG. 1c. Whereas 1c described only the horizontal shape of the optimized user space, FIG. 2 describes both the horizontal and the vertical shape. The 41 is eight feet wide by four feet tall and sits in the middle of a wall 48 sixteen feet wide by eight feet tall. The 59 is affixed to the ceiling along a bisector of 41 ten feet away. Trigonometry describes the angles required to vertically cover a user space with light such that a user located in a wide range of vertical heights will see light from every pixel on the display (calculations of vertical mirror curvatures are described in FIGS. 4d through 4f). The 59 produces a 43.6 degree field of light such that it covers the surface of 41. At a top right corner mirror 83, top right light 46 from the 59 is incident at an angle of 21.8 degrees horizontal and −11 degrees vertical compared to a normal to a wall 48. Light must be reflected from 83 vertically to cover the optimized vertical and horizontal space 55b which is the shaded area beginning 2 feet high and reaching 6 feet high and otherwise shaped according to FIG. 1c. Similarly, the 43b pixel must be shaped so as to vertically reflect light within the 55b shape as is described in FIGS. 4d and 4e. The 43b receives bottom left most light 44 from 59 at an incident angle of 21.8 degrees horizontal and −31 degrees vertical (compared to the normal to the wall 48) and must reflect light in a narrow two degree horizontal and in a wide vertical as calculated in FIGS. 4d and 4e.

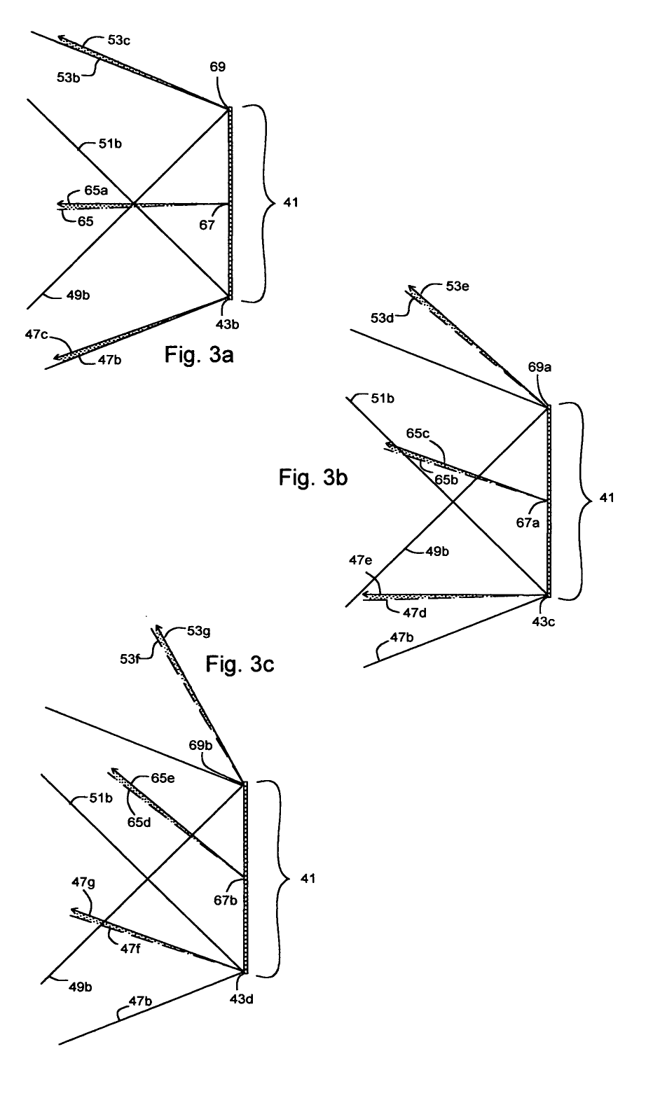

FIG. 3a is a top view of the projection screen of FIG. 2 showing three exemplary pixels projected over a period of 0.00009 seconds. During the depicted time frame, mirror 43b, a middle mirror 67, and a left most mirror 69 begin in positions parallel to the wall on which the 41 is mounted. As time progresses, light representative of a partial pixel of a single image is reflected from 43b across a two degree field of view from 47b to a first time left most reflected beam 47c. Similarly, the 67 reflects a partial middle pixel light 65 through a middle two degree beam 65a and the 69 reflects a right most partial pixel light through a two degree range form 53b through first time right most partial pixel beam 53c. As will be described later, all of the mirrors on the 41 are concurrently similarly presenting partial pixels across a respective two degree field of view.

FIG. 3b is a top view of the exemplary pixels of FIG. 3a projection over a subsequent 0.00009 second period. In practice according to the present invention, the second time left most light for 53d through first two degree advance 53e, need not be presented. Clearly, users will not be positioned in this portion of user space since they will not receive a full image and processing. When the first time rotated left most mirror 69a is in this position, presenting this pixel and other pixels on the far left of the display represents a waste of resources. Moreover as previously discussed, the performance of the DLP can be enhanced by not presenting light to portions of space where they will not be observed. Thus the shape of the optimal user space and/or the memory of user positions are incorporated into controlling logic used to determining which pixels to present and which not to present.

FIG. 3c is a top view of the exemplary pixels of FIG. 3b projection over a subsequent 0.00009 second period. Note that as the rotation angle of the mirrors progress, more of the pixels of a respective image are presented to portions of user space where no users will be present. Thus the pixels on the left side of the display need not be processed nor presented by the DLP and even pixels emanating from the middle of the display including 67b need not be processed/produced.

FIG. 4a is a top view of an exemplary mirror during the period described in FIG. 3a. The 43b rotates through one degree during the time that a first right most partial pixel 44 is displayed by the DLP projector such that the partial pixel is presented to a two degree wide field of view from 47b through 47c.

FIG. 4b is a top view of the exemplary mirror of FIG. 4a during the period described in FIG. 3b. The 43c rotates through one degree during the time that a second right most partial pixel 44a is displayed by the DLP projector such that the partial pixel is presented to a two degree wide field of view from 47d through 47e.

FIG. 4c is a top view of the exemplary mirror of FIG. 4a during the period described in FIG. 3c. The 43d rotates through one degree during the time that a third right most partial pixel 44b is displayed by the DLP projector such that the partial pixel is presented to a two degree wide field of view from 47f through 47g. All of the mirrors of the 41 are operated in unison with the mirror depicted in FIGS. 4a through 4c.

FIG. 4d is a side view of the method of deriving the necessary vertical curvature of mirror of FIG. 4a to ensure it fully addresses the entire vertical cross section of user space described in FIG. 2. As discussed in FIG. 2, the 44 lower right most beam from the DLP projector 59 is incident upon the lower right most mirror 43b at a vertical angle of 31 degrees off axis from a normal to the wall 48. In order to assure that users in the optimal viewing zone 55b of FIG. 2 are able to see light from the 43b no mater what their vertical position, within the two feet high to six feet high segment, the 43b must have a predefined curvature. The required curvature of 43b is calculated by determining what angle is required to reflect the 44 beam from its incident trajectory to a first top of vertical space trajectory 47b. This first lower mirror deflection angle 73 is calculated to be 36.3. Similarly, the lower mirror must include a surface that reflects light from the 44 trajectory to the lower vertical portion of viewer space. The lower mirror lower user space directing angle 71 is calculated as being 15.5 degrees. The 73 and 71 angles direct light to the extreme edges of the optimal viewer space 55b. All of the angles between 73 and 71 are required to direct light throughout the vertical range of optimal viewer space, these angles comprise the curve described in FIG. 4e.

FIG. 4e is a side view of the surface of the mirror with the curvature derived in FIG. 4d. All of the mirrors in the lowest row of the 41 have the same curvature as the 43b which is curved through an angle from 36.3 degrees to 15.5. In the illustration, a concave curvature is used, it is also possible to use a convex curvature. The rotating mirror array of preceding Figures is comprised of a large number of rotating mirrors each with vertical curvatures mathematically derived to distribute light vertically throughout a full vertical column of vertical space at any given instant in time while also send light to a very narrow horizontal portion of optimal user space 55b.

FIG. 4f is a side view of the method of deriving the necessary vertical curvature of the top row of mirrors described in FIG. 2 to ensure they fully addresses the entire vertical cross section of user space described in FIG. 2. Light from the DLP 59 is incident on the highest mirror 83 at an angle of eleven degrees off axis to a normal of the wall 48. The top row bottom reflecting angle 79 of −21 degrees is required to direct light to the front most bottom section of vertical optimized user space in 55b. The top row top reflecting angle 81 of 5.5 degrees is required to direct light to the front most top section of vertical user space in 55b. In order for the top row of mirrors to direct light to all of the vertical portions of the 55b user space, they must have a vertical curvature of between −21 degrees and 5.5 degrees. A concave curvature or a convex curvature of the surface of the 83 and other top row mirrors will distribute light vertically throughout optimal user space 55b.

The curvatures of all of the mirror rows between the bottom row including 43b and the top row including 83 can similarly be calculated depending upon the position of the 59, dimensions of the 41, and shape of the 55b. Generally speaking each row of mirrors will incrementally change form that of the bottom row to that of the top row.

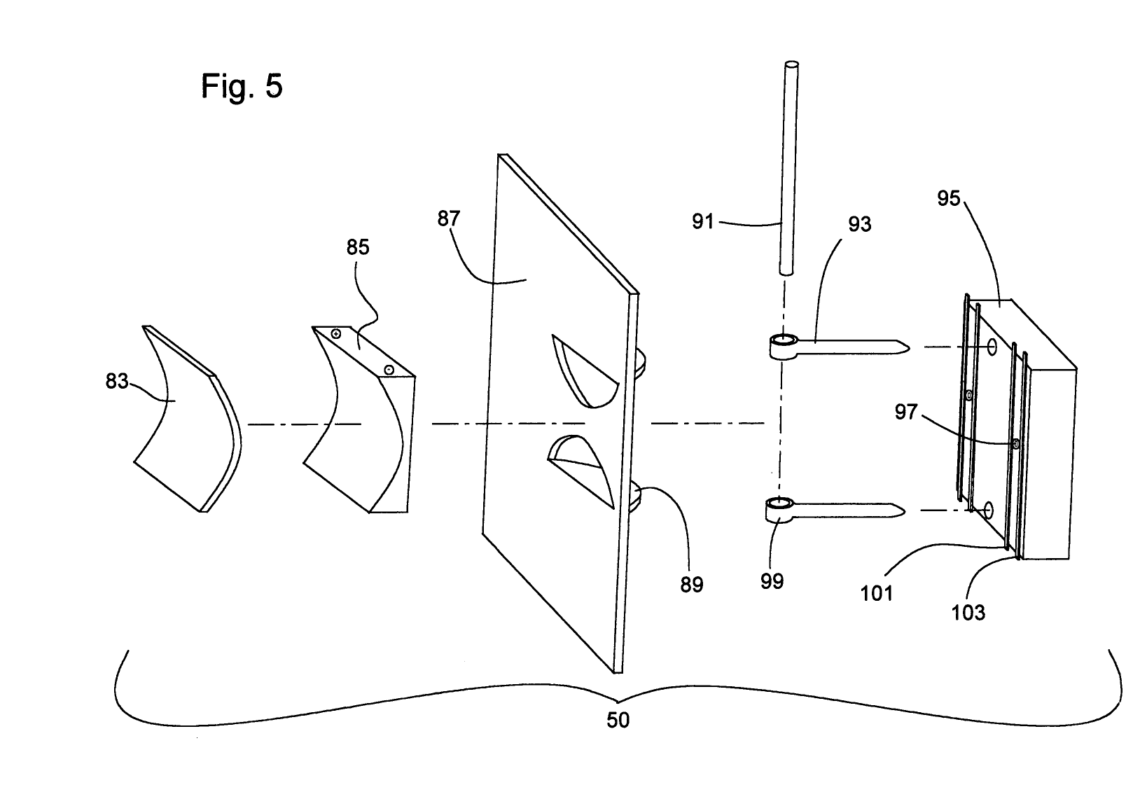

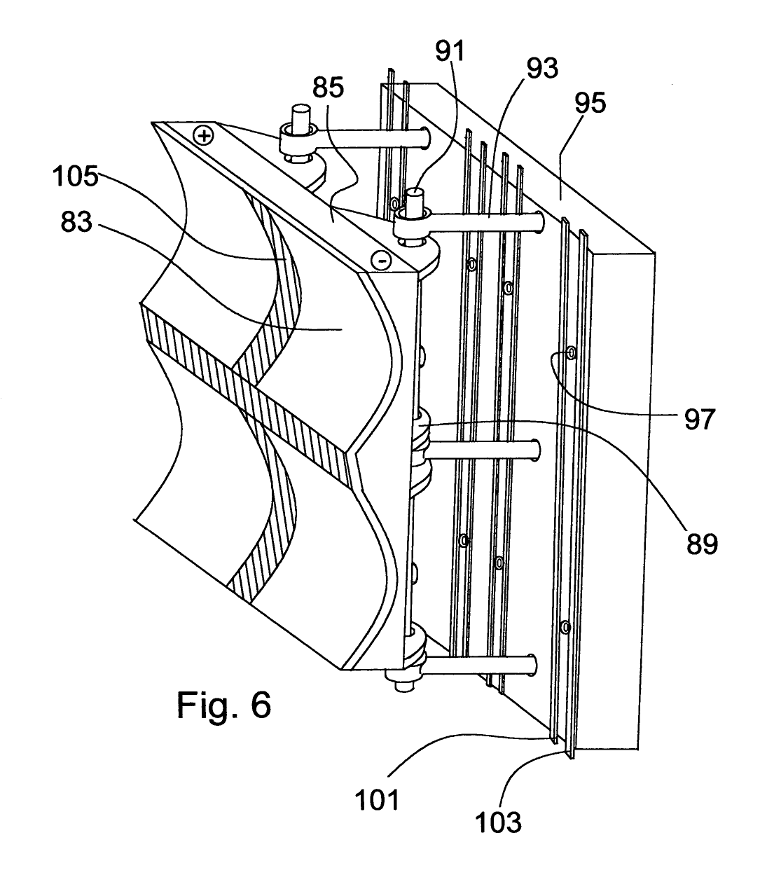

FIG. 5 is a perspective view of the method of assembling the components of a single rotating mirror shaped for full instant vertical distribution throughout user space (quasi vertically diffuse) but narrow instant horizontal distribution in user space (horizontally non-diffuse). The rotating mirror array projection screen 41 is comprised of 1408 columns by 1166 rows of rotating mirrors each 0.068 inch wide by 0.041 inch tall similar to an exploded mirror 50. While 50 is shown as a single element it is never, even during fabrication, a stand alone unit but is instead constructed as an integral part of the rotating mirror array. During the fabrication process an eight foot by four foot mold receives a liquid permanent magnet material which is allowed to solidify in the presence of a magnetic field so as to adopt a permanent magnet field. A single mirror sized magnetic subsection 85 of the eight foot by four foot molded permanent magnet substrate exemplifies one of the curves that are molded into the substrate and onto which is deposited a highly reflective non-diffuse mirror 83 made out of aluminum or chrome. An eight foot by four foot thin metal sheet 87 (only a small fraction of which is shown) is cut with two round holes (not shown) for each mirror's axel similar to a mirror axel 91 to be inserted through. The round holes are cut with a laser and once they are all cut, the 87 moves through a stamping process that stamps out two opposing semi circle shaped cuts for each mirror to bend the round holes into a position to receive the 91. Two such semi circles required for the fabrication of the 50 are shown including a mirror support 89 which has been cut and bent back during the stamping process. Another eight foot by four foot mold receives an electronic circuit comprising an array of components around which is poured a non-magnetic substrate that when cured forms a rigid substrate a small fraction of which is a mirror sized projection screen base 95. Upon installation of the display, it is the 95 and the rest of the rigid projection screen base that provide the rigidity of the projection screen and enable it to be hung on the 48 wall. Each mirror size segment of the projection screen base such as 95 include embedded therein two electromagnetic actuators including a first electromagnetic actuator 97. Each magnetic actuator includes a first electrical connection 101 and a second electrical connection 103. Also inserted into the 95 are two mirror support pins including a first support pin 93 and a second support pin 99. The 85 is affixed to the 87 which is then lined up with the 93 and 99 such that the 91 can be inserted through the 93, the two round holes in the 87, and through the 99. Lastly the 83 is deposited on the 85. As is described in FIG. 6, the fabrication at this stage consists of a rigid eight foot by four foot mirror where the 85 and 87 must then be cut with a laser to free them up from the large sheets of which they are a part during the fabrication steps to this point such that they can operate as an individually rotating unit. Note that a beam of barely divergent light from a 59 DLP that is incident upon 83 at any instance in time will be reflected vertically across the whole of the optimal user space 55b while being presented to a very narrow horizontal portion of the 55b optimal user space. Thus the light from 83 can be horizontally time sequenced and spatially multiplexed as the mirror rotates while not being vertically multiplexed and addressing the whole vertical user space.

FIG. 6 depicts a small fully assembled section of uncut mirrors that will form the projection screen of the present invention but prior to the last step of the fabrication process. As was discussed in FIG. 5, during the fabrication process, the elements of all of the mirrors are assembled in large eight foot by four foot sheets. FIG. 6 depicts a small section of the final assembly before the final fabrication stage of cutting with a laser the elements that will need to rotate. Note that the 91 is a rigid axel that is actually threaded through all of the vertical mirrors from 83 all the way down to 43b. When the 83 was deposited onto the 85, a mask was used to create a masked section 105 which is well suited to being cut with a laser.

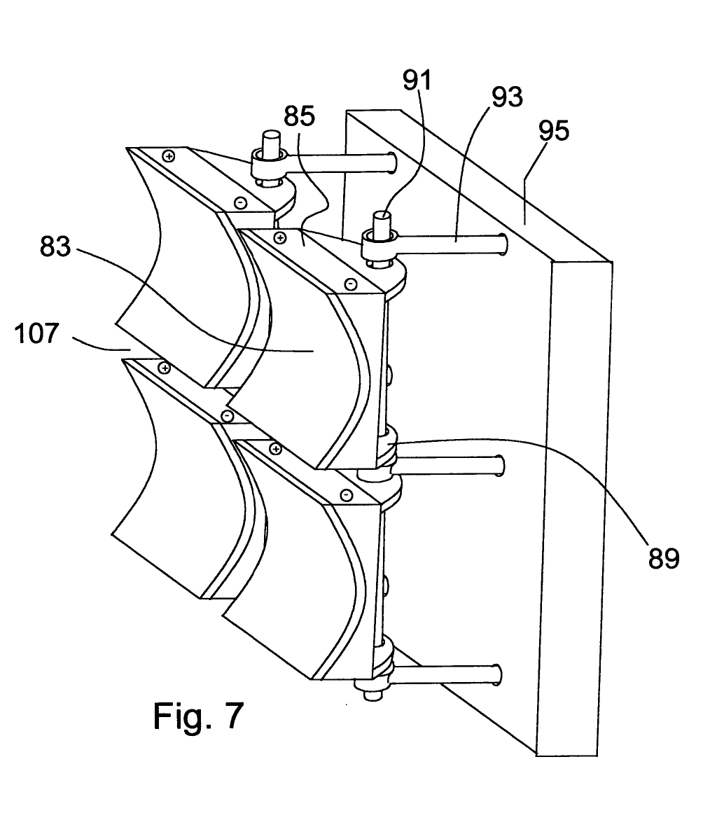

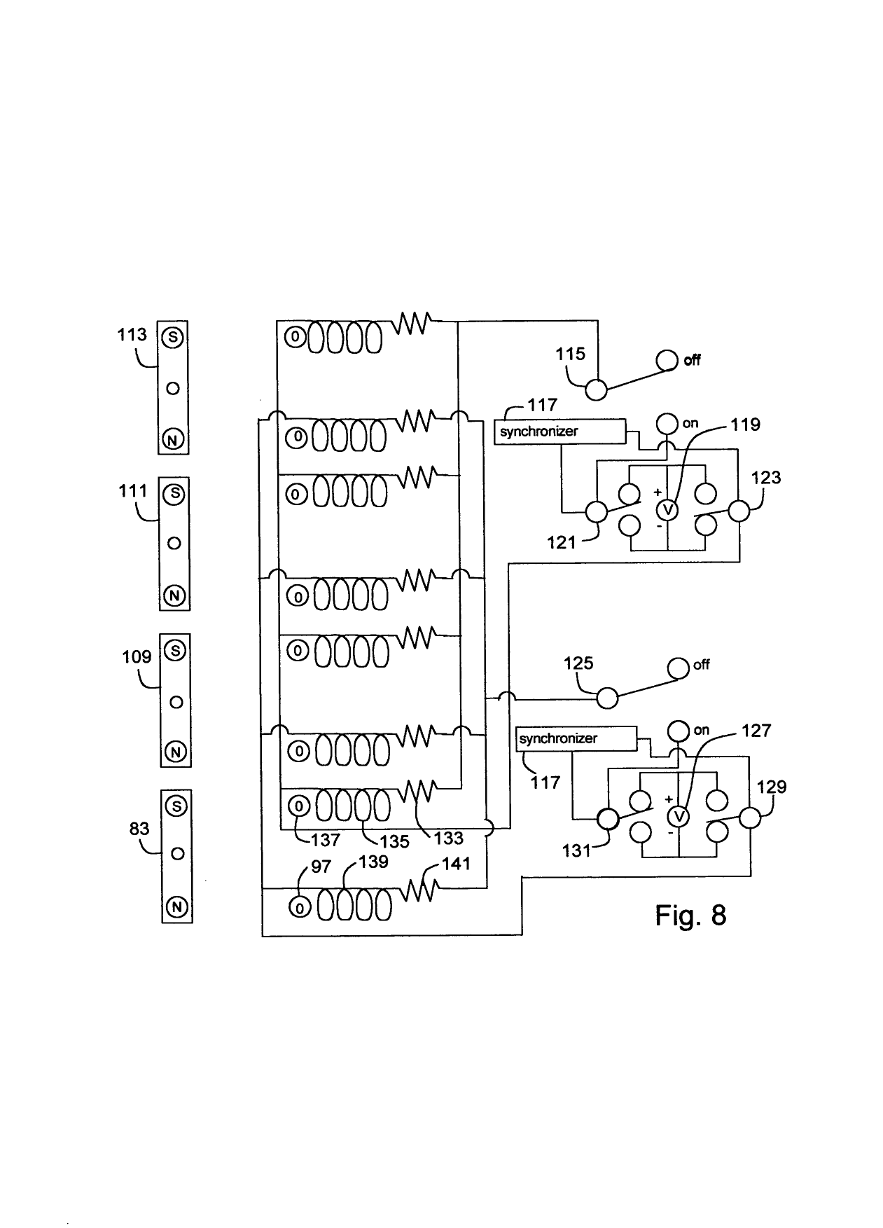

FIG. 7 depicts the small section of mirrors of FIG. 6 that comprise a portion of the rotating mirror projection screen of the present invention fully fabricated, cut and ready for operation. FIG. 7 shows that the 105 of FIG. 6 has been cut away such that the 83 mirror can rotate. Similarly all of the other mirrors in the finished assembly can rotate. Using the time sequenced spatially multiplexing method of the present invention, it is not necessary to individually address the rotation of each mirror. As discussed in FIGS. 8 through 10, each of the mirrors are rotated in unison.

FIG. 8 is a top view of a small section of a row of mirrors similar to those of FIG. 7 together with a schematic for controlling their actuation currently in the off state. A first on off switch 125 controls power to a portion of a circuit including the electromagnet 97 which is in a zero magnetic state since no current is flowing through a first coil 139 which is connected to a first resistor 141. Similarly, a second on off switch 115 controls power to a portion of a circuit including a second electromagnet 137 which is in a zero magnetic state since no current is flowing through a second coil 135 which is connected to a second resistor 133. When the circuit is in the off state, the mirrors of the array including the first mirror 83 reside in a flat plane due to their permanent magnet characteristics.

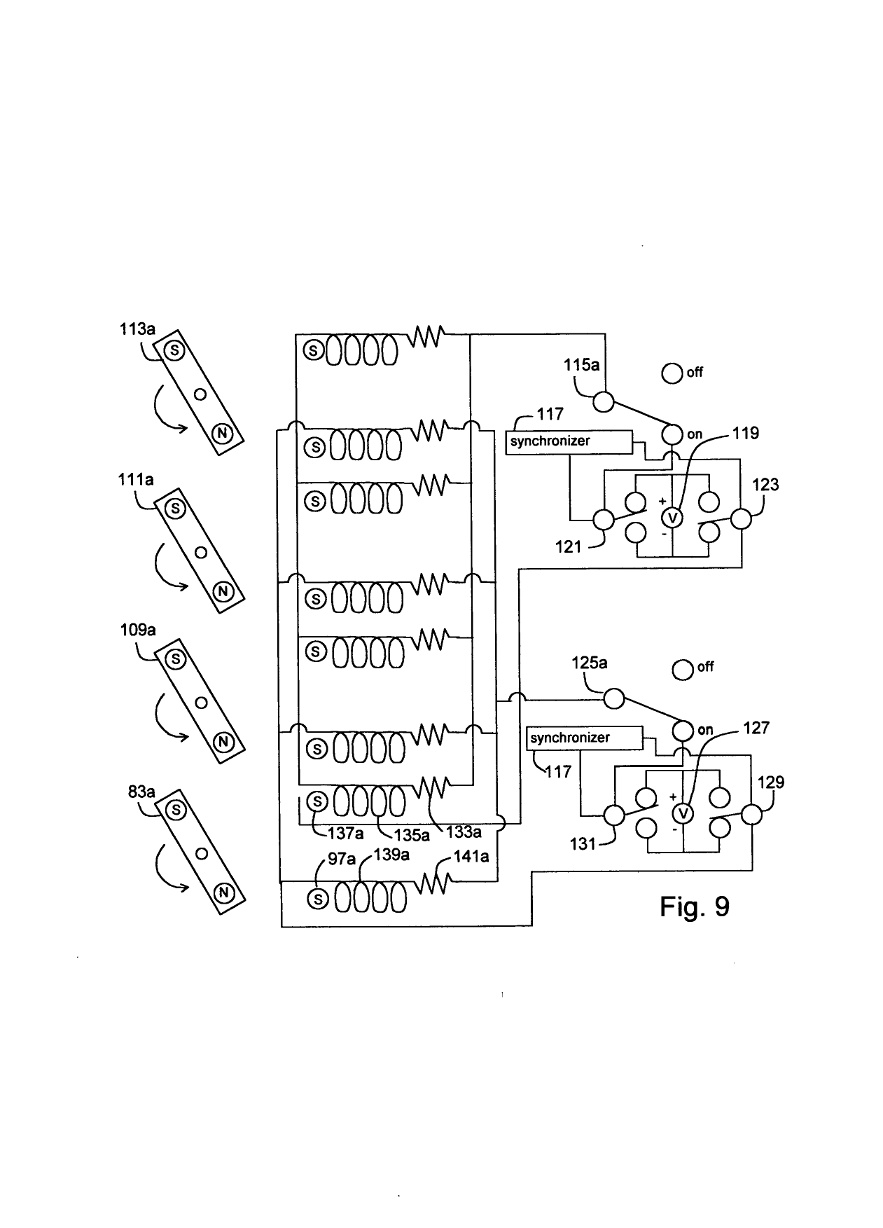

FIG. 9 describes the components of FIG. 8 in the on state at a first moment in time. Due to the presence of electromagnetic fields, each of the mirrors begin to rotate including first rotating mirror 83a, second rotating mirror 109a, third rotating mirror 11a, and fourth rotating mirror 113a. Note that all of the mirrors depicted as well as all the rest on the rotating mirror projection screen which are not shown rotate in unison. A first switch in on state 125a and a second switch in on state 115a turn on the power to the rotating mirror display. Current passes from a first voltage source 127 through a first oscillator switch 131 in response to a synchronizing signal produced by a synchronizer 117 which ensures that the images presented by the DLP are properly coordinated with the rotating mirror display such that the proper images and perspectives are presented to the proper user positions in the optimized user space 55b. Current flows from the 131 through a first current carrying resistor 141a through a first inducing coil 139a which cause a first magnetized electromagnet 97a to direct the south side of a magnetic field toward the 83a and thereby attracting its north end and repelling its south end. The current then completes the circuit traveling through a third oscillator switch 129 which is also controlled by the 117. Similarly, current passes from a second voltage source 119 through a second oscillator switch 121 in response to a synchronizing signal produced by the synchronizer 117 which ensures that the images presented by the DLP are properly coordinated with the rotating mirror display such that the proper images and perspectives are presented to the proper user positions in the optimized user space 55b. Current flows from the 121 through a second current carrying resistor 133a through a second inducing coil 135a which causes a second magnetized electromagnet 137a to direct the south side of a magnetic field toward the 83a and thereby attracting its north end and repelling its south end. The current then completes the circuit traveling through a fourth oscillator switch 123 which is also controlled by the 117

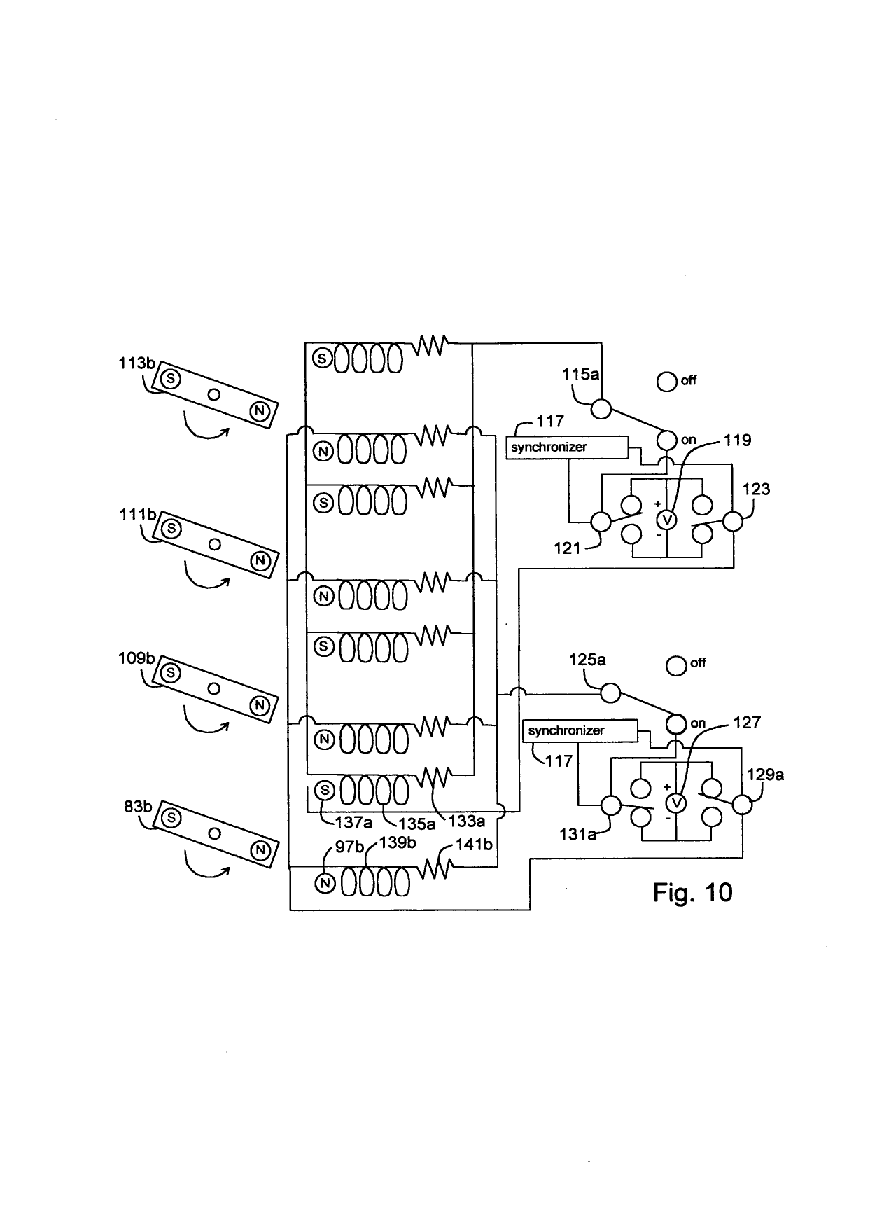

FIG. 10 describes the components of FIG. 9 at a second moment in time. In synchronization with the 117, a first switched oscillator switch 131a and a second switched oscillator switch 129a are each caused to flip such that current flow of one side of the circuit is reversed in FIG. 10 compared to FIG. 9. Current now flows from the 129a and through the reverse current coil 139b which induces a magnetic field in a reversed electromagnet 97b causing it to project a north pole magnetic field such that an advanced rotating mirror is repelled by the 97b while still being attracted by the 137a. Current then flows through the reversed resistor 141b to complete the circuit. Thus the present invention actuates the mirror array in unison using electromagnetic actuators interacting with the permanent magnetic fields on the rotating mirrors. Individual mirrors need not be addressed separately.

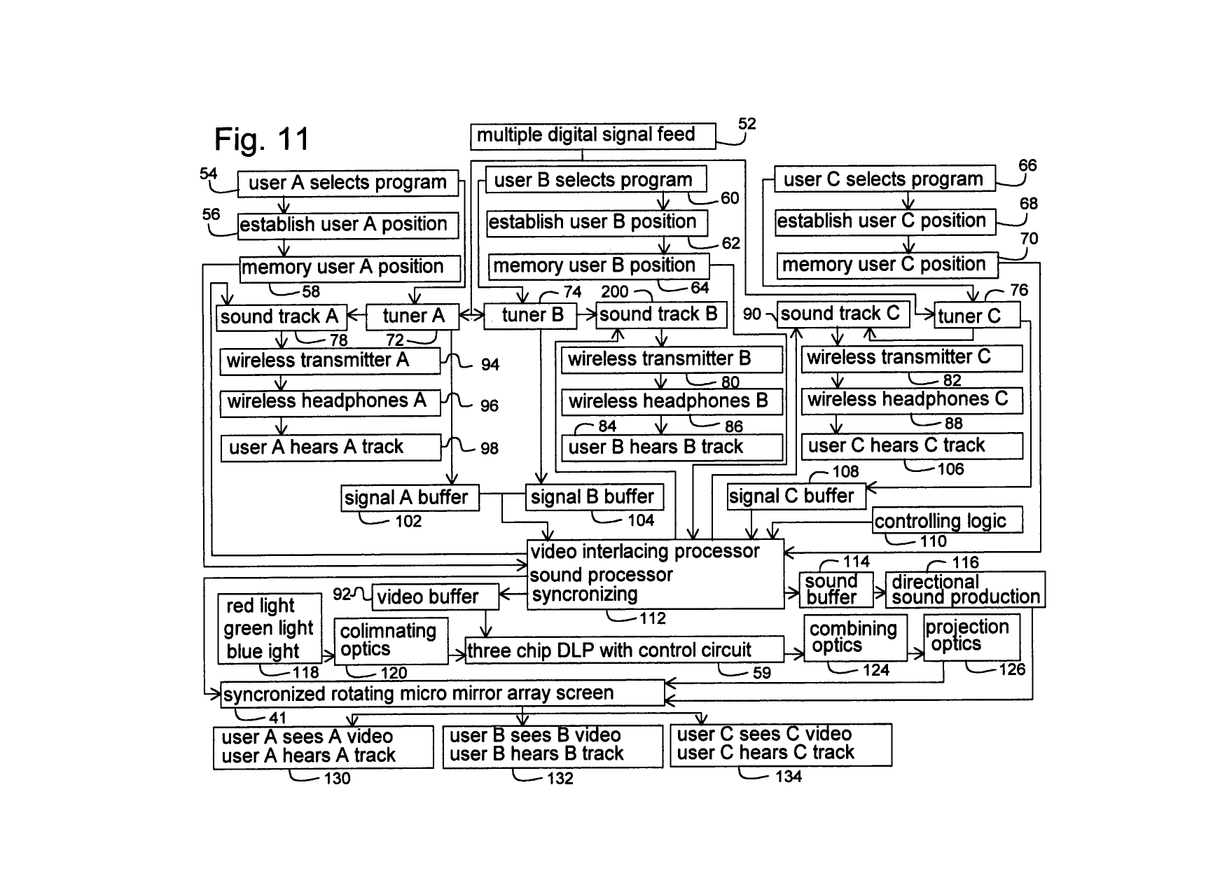

FIG. 11 depicts a flow chart describing the efficient operation of the present invention in the multiple program mode. A digital signal feed 52 comprises at least three separate streams of digital media. In a user A selects program A step 54, a television remote control is used. When the remote is used, a position of user A is established 56 and memory is kept of ‘user A’s position 58 while an A tuner 72 is tuned to User A's selection. Because of the technique of presenting alternate programs through the same three chip DLP of the present invention, signal buffers are maintained for each selected program such as a signal A buffer 102. The 102 enables a video interlacing processor/synchronizer 112 to periodically process an image from the A program from the 102 without loosing data when it is processing images from the other programs. Once the A program image is processed, it is stored in a video buffer 92 from which it is presented to the three chip DLP 59. The 59 comprises a set of red, green, and blue light sources 118 that are shaped by collimating optics 120, bounced off of each of three respective DLPs in 59, combined into a single beam by combining optics 124 which are generally dichroic mirrors, the light is then shaped through projection optics 126 and directed to the synchronized rotating micro mirror array screen 41. The video processor 112, uses controlling logic 110 which may include instructions to the 112 to look for the user A position 58, signal selection 54, optimal user space shape 55b, room shape, historic memory of past user locations, horizontal resolution, position of 59, size of 41, and/or feed back information about the rotational position of mirrors such as 83b to determine when to present what image pixels to the 59 for reflection off the 41 and presentation to user A. During the rotational cycle of the mirror such as 83b, it may receive pixel light as part of some images and not receive pixel light as part of other images depending upon how the logic 110 determines how to optimize performance of the processing 112 and operation of the DLP 59. Thus a user A sees A video program 130.

Two options to ensure user A hears A video and not other video programs are described. In a first sound option, sound track A 78 is split from the 72 and transmitted by a wireless transmitter 94, to be received by a wireless headphones A 96 which is worn by an A user who hears the A program 98. An alternate that still relies on the same transmitter and headphones steps is that the sound is processed by the 112 and then presented to the 94. This route is available in case the processing in 112 significantly delays the video product such that the sound split at the tuner A is out of sync with the video presented to 59. In any case, the user A hears the A program 98 while seeing the A video 130.

In a second sound option, the 112 as controlled by the 110 interlaces the sound stream and presents it to a sound buffer 114. The 114 has sound stored that directly correlates to the images stored in the 92 video buffer and as the images are presented to the DLP representative of three different video programs so are the sound streams presented to a directional sound system 116 representative of three different programs. Examples of companies that manufacture directional sound systems that project sound to specific areas of listener space such that a listener in a first position can hear sound that a person in a second position is unable to hear and Vic versa include Holosonic Research Labs, Inc. of Watertown, Mass., and American Technology Corporation of SanDiego, Calif. Sound and/or a sound carrying signal from the 116 is reflected off and directed by the rotating micro mirror array projection screen 41 concurrently with the video images such that user A sees A video on the projection screen while also hearing sound track A reflected from the 41. Due to the Doppler effect which is more pronounced in sound than light when dealing with rotational speeds on the order of sixty hertz, it may be necessary to incrementally increase the pitch of sound that will be incident upon the trailing half of a reflecting mirror while decrementally lowering the pitch of sound that will be reflected from the leading half of a rotating mirror.

User B initiates an identical process as described for user A above which results his hearing and seeing the B program. In a user B selects program B step 60, a television remote control is used. When the remote is used, a position of user B is established 62 and memory is kept of user B's position 64 while a B tuner 74 is tuned to User B's selection. Because of the technique of presenting alternate programs through the same three chip DLP of the present invention, signal buffers are maintained for each selected program such as a signal B buffer 104. The 104 enables a video interlacing processor/synchronizer 112 to periodically process an image from the B program from the 104 without loosing data when it is processing images from the other programs. Once the B program image is processed, it is stored in the video buffer 92 from which it is presented to the three chip DLP 59. The 59 comprises the set of red, green, and blue light sources 118 that are shaped by collimating optics 120, bounced off of each of three respective DLPs on 59, combined into the single beam by combining optics 124 which are generally dichroic mirrors, the light is then shaped through the projection optics 126 and directed to the synchronized rotating micro mirror array projection screen 41. The video processor 112, uses controlling logic 110 which may include instructions to the 112 to look for the user B position 62, signal selection 60, optimal user space shape 55b, room shape, historic memory of past user locations, horizontal resolution, position of 59, size of 41, and/or feed back information about the rotational position of mirrors such as 83b to determine when to present what image pixels to the 59 for reflection off the 41 and presentation to user B. During the rotational cycle of the mirror such as 83b, it may receive pixel light as part of some images and not receive pixel light as part of other images depending upon how the logic 110 determines how to optimize performance of the processing 112 and operation of the DLP 59. Thus a user B sees B video program 132.

Two options to ensure user B hears B video sound and not other video programs are described. In a first sound option, sound track B 200 is split from the 74 and transmitted by a wireless transmitter B 80, to be received by a wireless headphones B 86 which is worn by a B user who hears the B program 84. An alternate that still relies on the same transmitter and headphones steps is that the sound is processed by the 112 and then presented to the 80. This route is available in case the processing in 112 significantly delays the video production such that the sound split at the tuner B is out of sync with the video presented to 59. In any case, the user B hears the B program 84 while seeing the B video 132.

In a second sound option, the 112 as controlled by the 110 interlaces the sound stream and presents it to a sound buffer 114. The 114 has sound stored that directly correlates to the images stored in the 92 video buffer and as the images are presented to the DLP representative of three different video programs so are the sound streams presented to the directional sound system 116 representative of the sound tracks of the three video streams. Sound and/or a sound carrying signal from the 116 is directionally reflected off of the rotating micro mirror array projection screen 41 concurrently with the video images such that user B sees B video reflected from the projection screen 41 while also hearing sound track B reflected from the projection screen 41. Due to the Doppler effect which is more pronounced in sound than light when dealing with rotational speeds on the order of sixty hertz, it may be necessary to incrementally increase the pitch of sound that will be incident upon the trailing half of a reflecting mirror while decrement ally lowering the pitch of sound that will be reflected from the leading half of a rotating mirror.

User C initiates an identical process as described for user B above which results his hearing and seeing the C program. In a user C selects program C step 66, a television remote control is used. When the remote is used, a position of user C is established 68 and memory is kept of user C's position 70 while a C tuner 76 is tuned to User C's selection. Because of the technique of presenting alternate programs through the same three chip DLP of the present invention, signal buffers are maintained for each selected program such as a signal C buffer 108. The 108 enables a video interlacing processor/synchronizer 112 to periodically process an image from the C program from the 104 without loosing data when it is processing images from the other programs. Once the C program image is processed, it is stored in the video buffer 92 from which it is presented to the three chip DLP 59. The 59 comprises the set of red, green, and blue light sources 118 that are shaped by collimating optics 120, bounced off of each of three respective DLPs on 59, combined into the single beam by combining optics 124 which are generally dichroic mirrors, the light is then shaped through the projection optics 126 and directed to the synchronized rotating micro mirror array projection screen 41. The video processor 112, uses controlling logic 110 which may include instructions to the 112 to look for the user C position 68, signal selection 66, optimal user space shape 55b, room shape, historic memory of past user locations, horizontal resolution, position of 59, size of 41, and/or feed back information about the rotational position of mirrors such as 83b to determine when to present what image pixels to the 59 for reflection off the 41 and presentation to user C. During the rotational cycle of the mirror such as 83b, it may receive pixel light as part of some images and not receive pixel light as part of other images depending upon how the logic 110 determines how to optimize performance of the processing 112 and operation of the DLP 59. Thus a user C sees C video program 134.

Two options to ensure user C hears C video sound and not other video programs are described. In a first sound option, sound track C 90 is split from the 76 and transmitted by a wireless transmitter C 82, to be received by a wireless headphones C 88 which is worn by a C user who hears the C program 106. An alternate that still relies on the same transmitter and headphones steps is that the sound is processed by the 112 and then presented to the 82. This route is available in case the processing in 112 significantly delays the video production such that the sound split at the tuner C is out of sync with the video presented to 59. In any case, the user C hears the C program 106 while seeing the C video 134.

In a second sound option, the 112 as controlled by the 110 interlaces the sound stream and presents it to a sound buffer 114. The 114 has sound stored that directly correlates to the images stored in the 92 video buffer and as the images are presented to the DLP representative of three different video programs so are the sound streams presented to the directional sound system 116 representative of the sound tracks of the three video streams. Sound and/or a sound carrying signal from the 116 is directionally reflected off of the rotating micro mirror array projection screen 41 concurrently with the video images such that user C sees C video reflected from the projection screen 41 while also hearing sound track C reflected from the projection screen 41. Due to the Doppler effect which is more pronounced in sound than light when dealing with rotational speeds on the order of sixty hertz, it may be necessary to incrementally increase the pitch of sound that will be incident upon the trailing half of a reflecting mirror while decrement ally lowering the pitch of sound that will be reflected from the leading half of a rotating mirror.

The 112 of FIG. 11 is sending three different programs to the DLP 59 according to the controlling logic 110 for presentation to specific physical locations in an optimized viewing space 55b such that 130, 132, and 134 each respectively hear and see three completely different programs on the rotating micro mirror projection screen at the same time full screen size and full resolution.

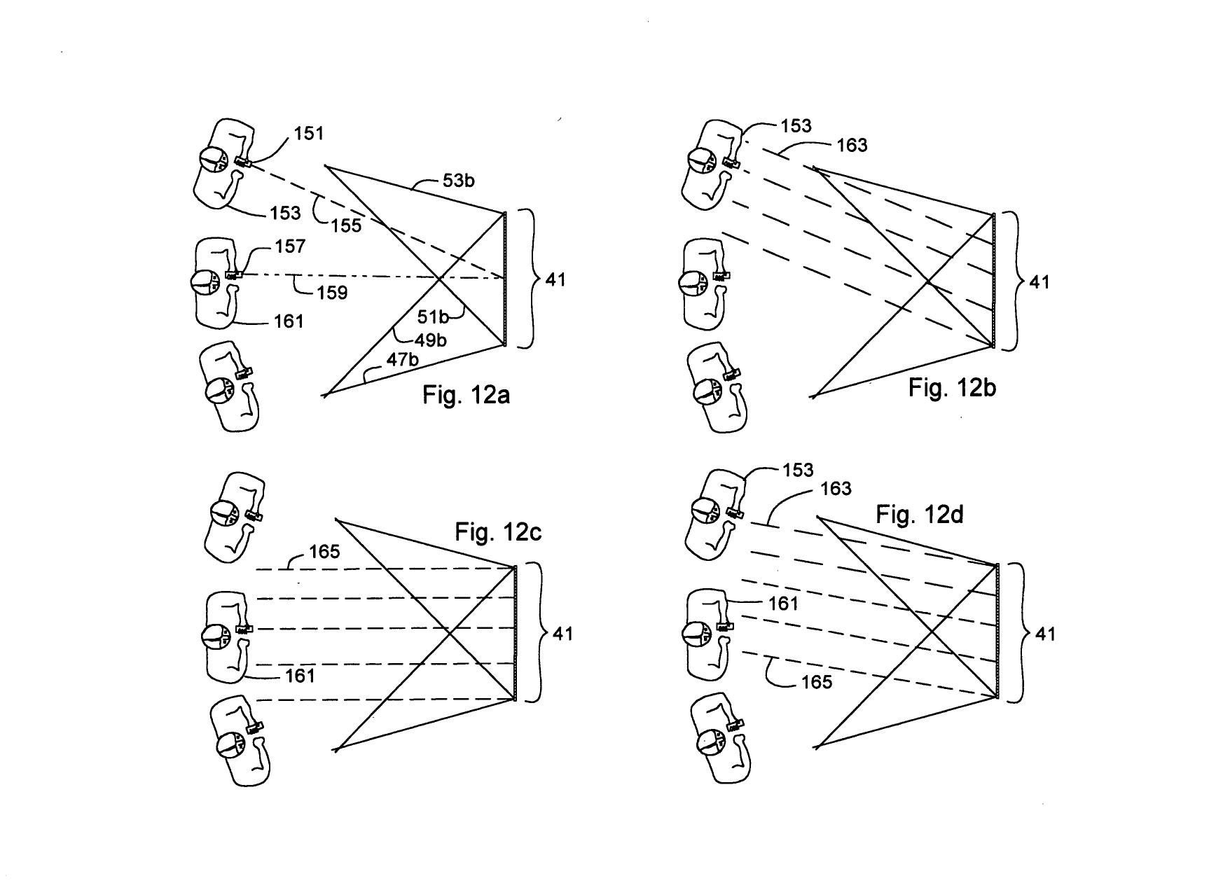

FIG. 12a illustrates a top view of multiple users selecting programming choices on the present display. User A 153 of FIG. 11 uses a first remote control 151 to send a first infrared signal 155 to a signal receiver (not shown) which registers A's program selection and A's physical position. User B 161 of FIG. 11 uses a second remote control 157 to send a second infrared signal 159 to a signal receiver (not shown) which registers B's program selection and B's physical position.

FIG. 12b depicts the display of FIG. 12a presenting a first program to a first user. At an instant in time, the mirrors on 41 direct an image of the A video 163 to the A viewer 153.

FIG. 12c depicts the display of FIG. 12b at a subsequent time presenting a second program to a second user. At a subsequent instance in time, the rotating mirrors of the 41 present a B video 165 to the B user 161.

FIG. 12d depicts the display of FIG. 12c at a subsequent time presenting a first program to a first user and concurrently a second program to a second user. Depending upon the instructions from the controlling logic 110, the processor 112 may create images that include a half frame of the A 163 video stream and a half frame of the B video stream 165. This creates very wide program viewing zones with clear distinctions between zones such that 153 and 161 are concurrently able to move around easily within their specific viewing zone and continue to see only their selected program from all mirrors on the projection screen 41.

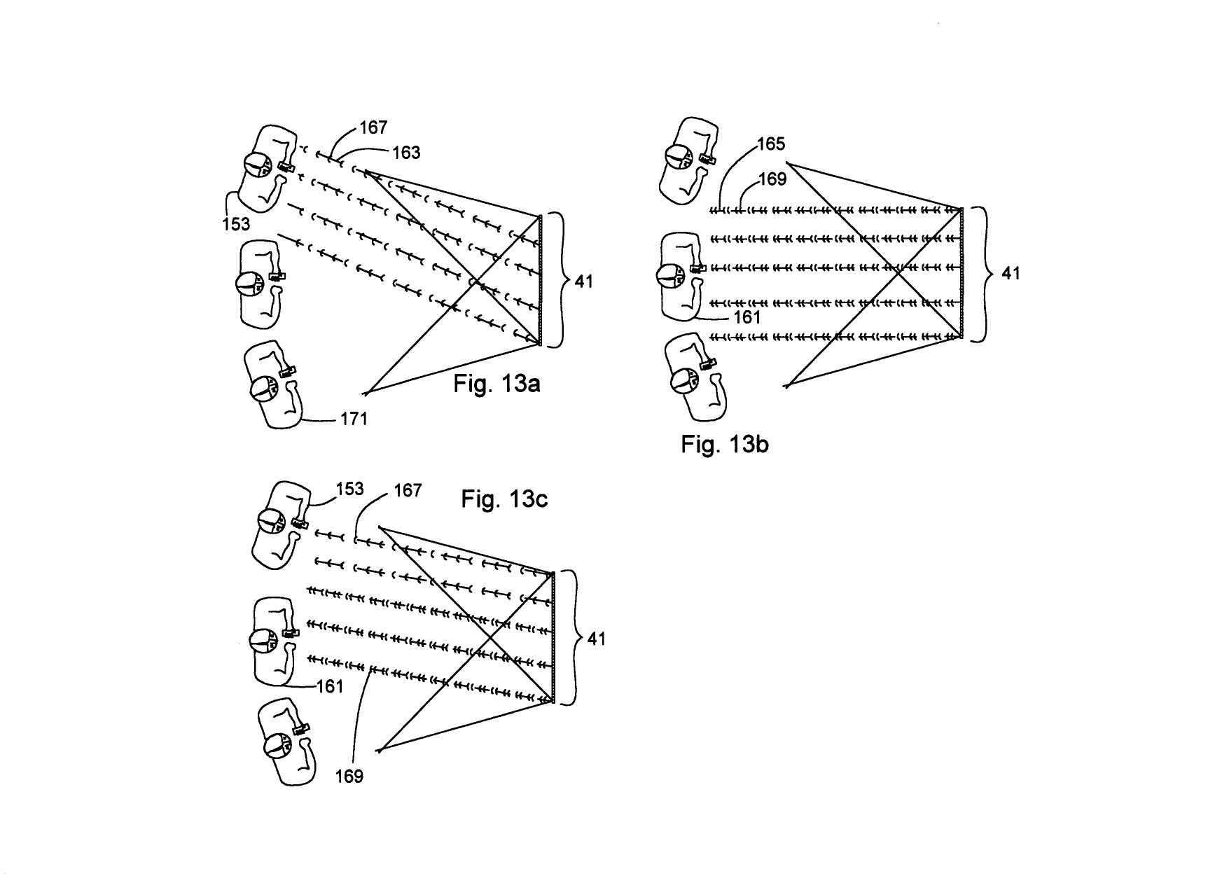

FIG. 13a is identical to FIG. 12b except that a directional sound carrier is concurrently reflected from the projection screen to the first user. Sound from the A program 167 can be reflected off the 41 and directed to the A user 153 along with the A video 163. User C 171 will neither see 163 nor hear 167 from his position.

FIG. 13b is identical to FIG. 12c except that a directional sound carrier is concurrently reflected from the projection screen to the second user. Sound from the B program 169 can be reflected off the 41 and directed to the B user 161 along with the B video 165.

FIG. 13c is identical to FIG. 12d except that a directional sound carrier is concurrently reflected from the projection screen to both the first and second users. Depending upon the instructions from the controlling logic 110, the processor 112 may create images that include a half frame of the A 163 video stream and a half frame of the B video stream 165. Similarly, the directional sound system 116 may split sound production such that the A sound 167 is directed to the A user 153 while concurrently the B sound 169 is directed to the B user 161. This creates very wide program viewing zones with clear distinctions between zones such that 153 and 161 are concurrently able to move around easily within their specific viewing zone and continue to see and hear only their selected program from all mirrors on the projection screen 41.

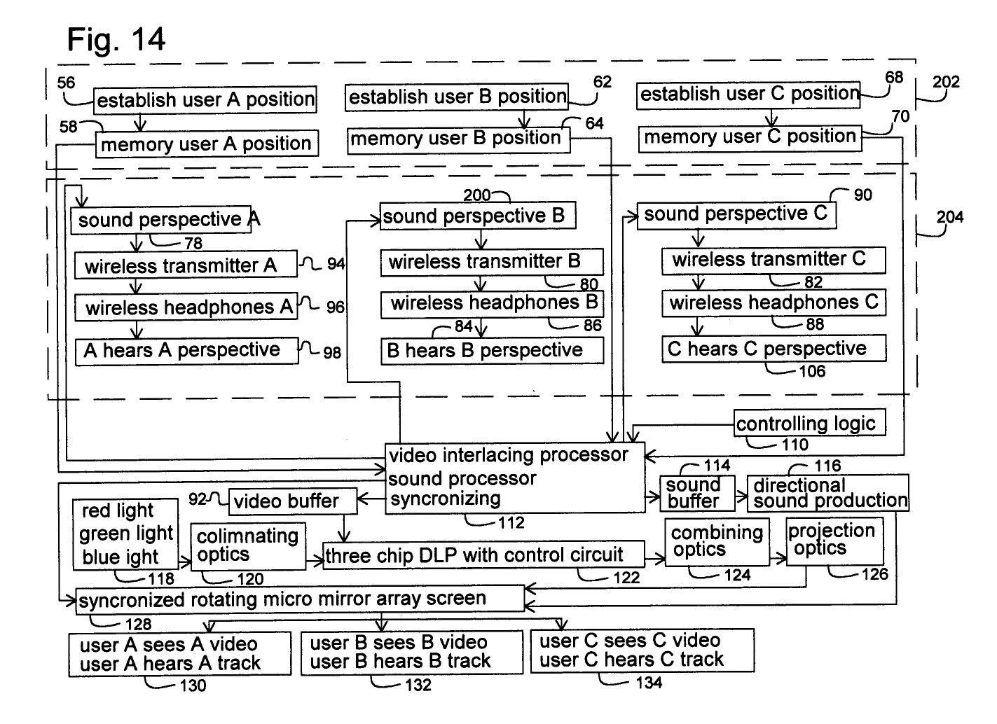

FIG. 14 depicts a flow chart describing the efficient operation of the present invention in the auto-stereoscopic 3D mode. A first optional sub-routine 202 involves identifying where respective users of the system are located as a means to produce customized views for each specific user which can have optimized horizontal parallax with resolution finer than 0.05 degrees as previously discussed herein. If the position of users is not identified, the system will simply produce a predetermined number of viewing perspectives with a corresponding horizontal parallax resolution such that any number of users of the display each located within the optimized viewing zone 55b will concurrently see perspective correct images with two degree horizontal resolution from all mirrors on the display. Either with very high horizontal parallax resolution for a limited number of perspectives or lower horizontal parallax resolution across the whole user space the rotating micro mirror display screen 44 operates essentially identically with all mirrors rotating at 60 hertz in unison and synchronized according to the 112. When employing the 202 sub-routine, a user A position is established 56 and stored in memory user A position 58, a user B position is established 62 and stored in memory user B position 64, and a user C position is established 68 and stored in memory user C position 70. Establishing positions can be achieved with head tracking hardware and software (not shown) that is know in the art of 3D displays. The positions of users A, B, and C is called from memory by the 112 as needed when producing images according to the logic of 110 to calculate what images should be constructed for optimal horizontal resolution within processing and DLP performance constraints.

A second optional sub-routine 204 is that of positionally dependant sound production. When this routine is used, sound heard by each of the users A, C, and C is dependant upon their physical position. This subroutine must use the 202 routine since the position of users must be know in order to present sound to them through head phones. If using the directional sound system, the 202 routine is not necessary.

The steps of the 3D flow chart listed in FIG. 14 using the present invention are the same as the steps of displaying multiple programs of FIG. 11 except as discussed herein.

Operation of the Invention

Operation of the invention has been discussed under the above heading and is not repeated here to avoid redundancy.

### CONCLUSION, RAMIFICATIONS, AND SCOPE

Thus the reader will see that the Processes and Apparatuses for Efficient Multiple Program and 3D Display of this invention provides a novel unanticipated, highly functional and reliable means for distributing multiple video streams to segmented user spaces such that users within each respective space can view distinct video streams or true 3D views of the same video stream.

While the above description describes many specifications, these should not be construed as limitations on the scope of the invention, but rather as an exemplification of a preferred embodiment thereof. Many other variations are possible. Many types of video monitors are well known and can be used with the method and elements described herein. For example, many techniques for projecting images are well known and could be used by one skilled in the art to physically segment multiple video streams according to the present invention. Many optical elements and combinations thereof are possible. Many optical arrangements of intervening optics have been described herein and others are possible using that which is taught herein. Many reflector configurations are possible. The rotating mirrors can be curved horizontally and also can have other shape characteristics to horizontally shape how images are presented to optimize viewer space. The variable Fresnel mirror arrays using elastic reflective membranes described by the present inventor in U.S. Pat. No. 6,552,860 and other patents may be used as an accountable micro mirror array in place of and performing substantially the same function as the rotating micro mirror array described herein. In another application, the rotating micro mirror array can be used to direct electromagnetic energy to a sensor as essentially an adaptive optic that uses time sequencing to select when light from a specific mirror will be sensed and can operate in response to changes refractive properties in the Earth's atmosphere for example and in such an application, the whole adaptive optic micro mirror array can be additionally actuated to rotate as a unit around an imaginary axis at a normal to its midpoint. The memory may contain information about the historical positions of users such that the user space can be optimized further to present images optimally for these specific common user positions. Vertical curvature of the individual mirrors can be convex instead of concave. While it is recommended that the width of the rotating mirrors be less than or equal to the width of incident pixels it is not mandatory. Also the height of the rotating mirrors are described herein as being smaller than the height of incident pixels but this need not be the case. In fact more efficient mirrors are multiple pixels high with multiple vertical curvatures on the scale of those described herein. In addition to a DLP based projector, high speed projection using a three CRT system is also possible as are other projection techniques. The reflecting screen shape can be any dimensions. The back side of the mirrors could also be used as reflectors of sound or electromagnetic radiation. All surfaces not specifically described herein as being reflective are assumed to be absorptive of electromagnetic radiation and/or sound. Many solid state beam steering or deflecting techniques are known in the prior art. It should be understood that the term “display” and/or “screen” refers to a screen for receiving a light projection which is then viewed by an observer for the purpose of seeing a video monitor, is television screen, a computer display, a video game screen, or device which substantially provides images to a user.

The prior related patent applications of the present applicant which are cross referenced herein also contain relevant information which is incorporated herein by reference but not repeated to avoid redundancy.

What is claimed:

1. A front projection screen for providing a first image to a first portion of user space and a second image to a second portion of user space wherein a user in the first portion of space can see the first image but can not see the second image and wherein time sequencing is used to direct images to each respective user space.
